(19) United States
(12) Patent Application Publication
(10) Pub. No.: US 2017/0213468 A1
(43) Pub. Date: Jul. 27, 2017

(54) PROXIMITY DETECTION SYSTEM

(71) Applicant: Garmin International, Inc., Olathe, KS (US)

(72) Inventors: Noel J. Duerksen, Spring Hill, KS (US); Didier Papadopoulos, Olathe, KS (US)

(21) Appl. No.: 15/005,422

(22) Filed: Jan. 25, 2016

(51) Int. Cl. G08G 5/04; B64D 45/00; B60R 16/033

(52) U.S. Cl. CPC G08G 5/04; B60R 16/033; B64D 45/00

(57) ABSTRACT

A sensor system is described that leverages low power motion sensors to trigger the activation of higher power proximity sensors. The system may be configured to monitor the motion of a vehicle, such as an aircraft in which it is installed. The sensor system may initially start in a dormant state, and once the vehicle is moved, such as when an aircraft is towed, a proximity sensor may be activated, which draws power from a dedicated battery unit. Once the proximity sensor is activated, the sensor system may continue to monitor proximity data generated by the proximity detection system and sound an alarm if the vehicle comes within a threshold distance of some object. The sensor system may also utilize state of the vehicle's electrical system to recharge the battery and/or to disable various components, thereby optimizing power consumption.

### TECHNICAL FIELD

The present disclosure relates generally to a proximity detection system and, more particularly, to controlling the power consumption of a proximity detection system utilizing the motion of a vehicle and/or the power state of the vehicle.

### BACKGROUND

Various types of vehicles may utilize proximity sensors to detect the proximity of objects that an operator may not be able to see. For example, proximity sensors have been placed in the rear bumper of cars to provide audible feedback to a driver when backing up.

However, conventional proximity sensors typically draw electrical power from the vehicle in which they are implemented. Because proximity sensors are most useful when the vehicle is in motion, and these vehicles typically move under their own power, these proximity sensors are typically powered by the vehicle's power system. For aircraft, this may require the aircraft's electrical system to be switched on, a practice that is ordinarily cumbersome or even impossible to achieve while an unoccupied aircraft is being towed around the ramp area, to and from a hangar, and inside a hangar. Therefore, typical proximity sensors are not utilized with aircraft as the aircraft's electrical system cannot be continuously operated to run proximity systems.

### SUMMARY

Embodiments are disclosed describing a proximity detection power management system. The proximity detection power management system may include one or more proximity sensors, motion sensors, a dedicated battery, and switching controls. The proximity sensors may be mounted at various locations within and/or outside of a vehicle. In embodiments in which the vehicle is an aircraft, the proximity sensors may be installed at various extremities of an airplane or helicopter such as the tail, nose, wingtips, tail booms, rotors, rotor tips, the vertical and horizontal stabilizers, combinations thereof, etc.

The one or more motion sensors may be mounted in the vehicle and generate motion data indicative of the vehicle's motion. The one or more motion sensors may be initially powered from one or more dedicated battery(s) while the vehicle is stationary. In this dormant state (dormant mode of operation), the proximity sensors remain unpowered and “offline.” However, upon the motion data indicating that the vehicle has moved, the proximity sensors may transition to an active state (active mode of operation) and draw power from one or more dedicated battery(s). In the active mode of operation, embodiments include the proximity sensors detecting objects within a threshold distance and/or generating proximity data to indicate a distance between each proximity sensor and various external objects that may pose a risk of collision with the vehicle. In either case, the proximity detection power management system may issue an alert inside and/or outside of the vehicle. This may allow the proximity detection power management system to be operational for some time without relying on the vehicle's internal electrical power, thereby facilitating proximity detection while the vehicle is in an unpowered state—such as during an aircraft towing procedure.

In other embodiments, the proximity detection power management system may detect whether the vehicle is in an unpowered or a powered state and control the flow of power to various components based upon this information. Further in accordance with such embodiments, the proximity detection power management system may, upon the vehicle switching to a powered state, switch to an off state (off mode of operation) in which the proximity detection functions are disabled and the vehicle power is used to recharge the dedicated battery(s).

In other embodiments, the proximity detection power management system may still function in the active proximity detection state when the vehicle is in a powered state or switch to an off state or a dormant state based upon other vehicle sensor inputs indicating that the vehicle is engaged in active flight. These embodiments may retain proximity detection functions while the vehicle is taxiing, switch off the proximity detection functions after an aircraft has taken off, or retain the proximity detection functions throughout a flight.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, whenever possible, the following description refers to the reference numerals included in the following figures, in which features depicted in multiple figures are designated with consistent reference numerals.

FIG. 1 is an illustration of a schematic illustration of an exemplary airplane proximity detection power management system 100, in accordance with an embodiment of the present disclosure;

FIG. 2 is an illustration of a schematic illustration of an exemplary helicopter proximity detection power management system 200, in accordance with an embodiment of the present disclosure;

FIG. 3 is a block diagram of an exemplary proximity detection power management system 300, according to an embodiment;

FIG. 4 illustrates a method flow 400, according to an embodiment; and

FIG. 5 illustrates a method flow 500, according to an embodiment.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. In light of the teachings and disclosures herein, numerous alternative embodiments may be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

Although the following examples and embodiments described throughout this disclosure are often directed to the use of a proximity detection power management system in various types of aircraft, the embodiments described herein are equally applicable to any suitable type of vehicle in which proximity detection may be utilized. For example, the embodiments described herein may be implemented as part of a car, a truck, a boat, a spacecraft, etc. Furthermore, although specific examples are provided herein regarding the implementation of various embodiments in an airplane and helicopter, these are exemplary and not intended to limit the term “aircraft.” As used throughout the disclosure, the term “aircraft” may apply to any suitable vehicle used for sustained flight, such as airplanes, rotorcraft, gliders, airships, etc. In addition to aircraft, the technology is applicable to any large object that moved using an external power source and for which visibility of potential collisions is restricted or difficult, such as a ship or barge being towed in a harbor.

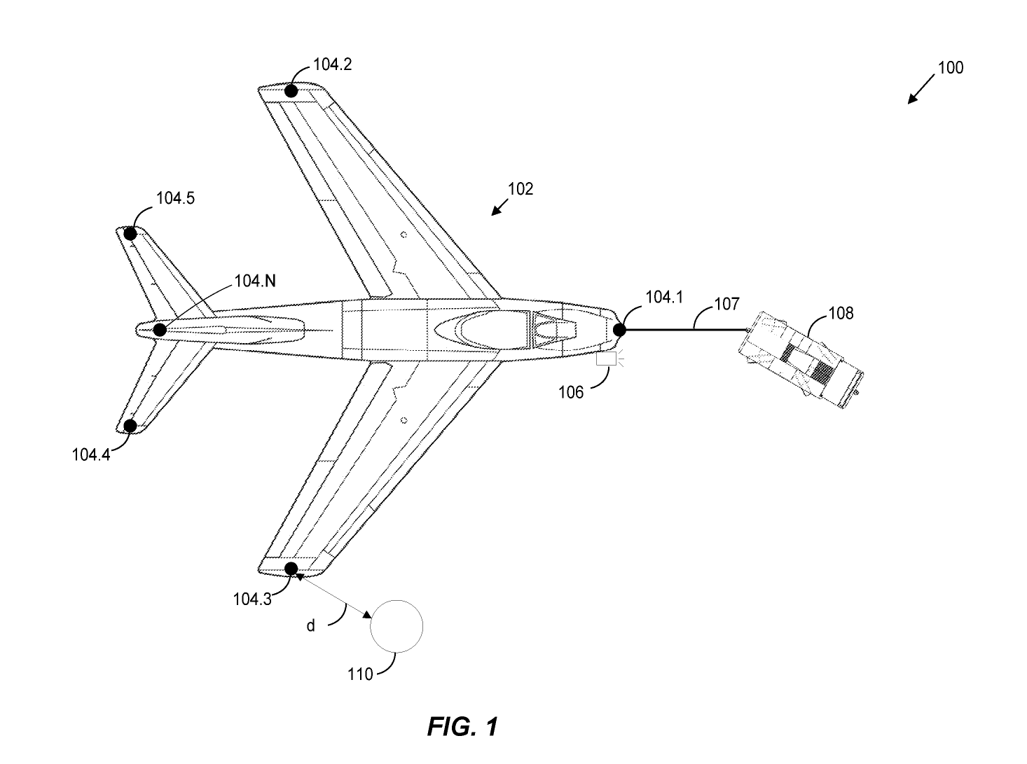

FIG. 1 is an illustration of a schematic illustration of an exemplary airplane proximity detection power management system 100, in accordance with an embodiment of the present disclosure. Airplane proximity detection power management system 100 may include an airplane 102, any suitable number N of proximity detection units 104.1-104.N, an alarm unit 106, a tow bar 107, a tow vehicle 108, and one or more external objects 110.

In various embodiments, airplane 102 may include any suitable number N of proximity detection units, which may be installed at various locations of airplane 102. Proximity detection units 104.1-104.N may be installed at locations in airplane 102 to advantageously provide proximity detection data for those portions of airplane 102 that are most likely to be damaged by a collision into one or more external objects 110. For example, as shown in FIG. 1, proximity detection unit 104.1 may be installed in the nose of airplane 102, proximity detection units 104.2 and 104.3 may be installed in the wingtips of airplane 102, proximity detection unit 104.4 and 104.5 may be installed at the extremities of the horizontal stabilizer, and proximity detection unit 104.N may be installed in the extremity of the vertical stabilizer.

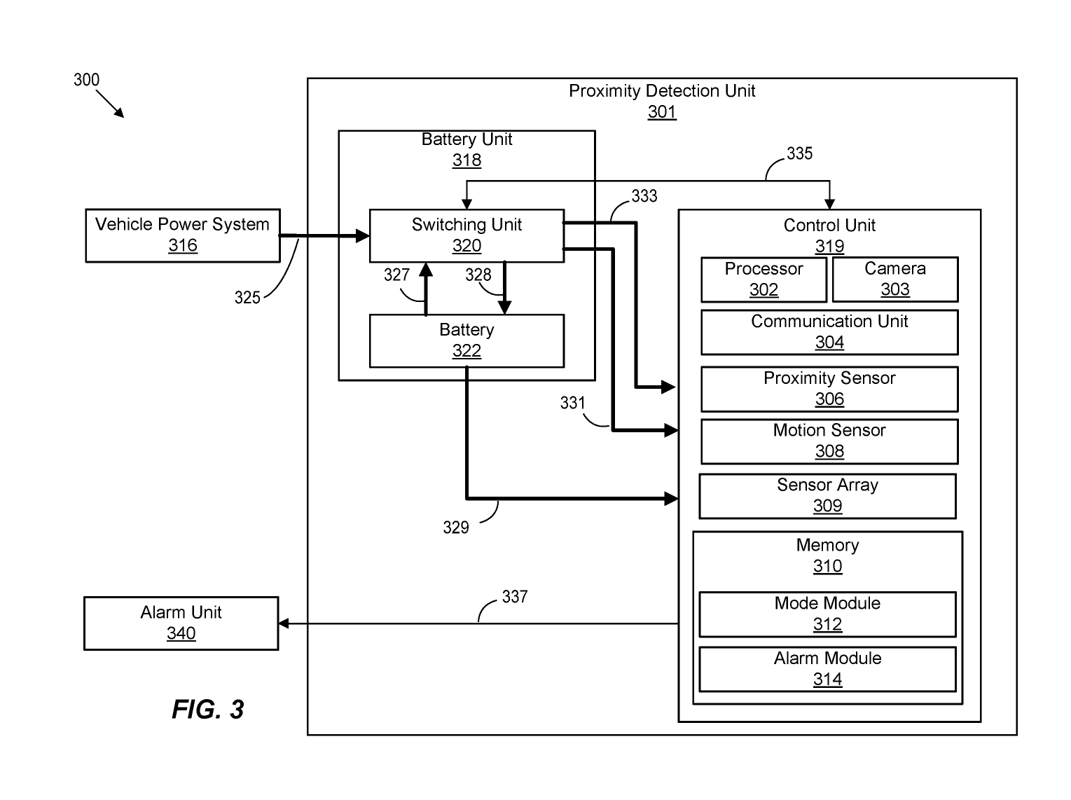

One or more of proximity detection units 104.1-104.N may be installed as modular units at various locations of airplane 102, which is further discussed below with reference to FIG. 3. Based upon their installation locations, one or more proximity detection units 104.1-104.N may access and utilize the electrical system of airplane 102. For example, proximity detection units 104.2-104.3 may utilize electrical wiring that is in place to power the wingtip lights proximate to their installation locations, while proximity detection unit 104.N may utilize electrical wiring that is in place to power airplane 102's taillights.

In various embodiments, one or more of proximity detection units 104.1-104.N may implement proximity sensors that utilize frequencies that are mostly unaffected by non-metallic aircraft construction materials, such as fiberglass, for example. In accordance with such embodiments, one or more of proximity detection units 104.1-104.N may be mounted inside wingtips, fairings, etc., thereby allowing their installation without changing the shape or structure of the components of airplane 102.

In some embodiments, one or more of proximity detection units 104.1-104.N may include various components integrated as part of each respective proximity detection unit 104.1-104.N, such as a motion sensor configured to detect the motion of airplane 102 and/or a dedicated battery, which is further discussed below with reference to FIG. 3. These embodiments may be particularly useful when a modular installation is desired for each of proximity detection units 104.1-104.N.

In other embodiments, one or more proximity detection units 104.1-104.N may share various components, such as motion sensors and/or dedicated batteries, which may be installed at any suitable location within airplane 102 or be included with the modular installation of one or more of proximity detection units 104.1-104.N, as discussed above. These embodiments may be particularly useful when a low-cost installation is desired for each of proximity detection units 104.1-104.N, as fewer components may be required.

Regardless of the installation and configuration of motion sensors and/or dedicated batteries in airplane proximity detection power management system 100, embodiments may include the airplane proximity detection power management system 100 being placed into a dormant state, or low-power mode of operation, while airplane 102 is not exceeding a threshold level of movement. This operating mode may be controlled based upon motion data generated by the one or more motion sensors, which may be powered from the dedicated battery—independent of the aircraft's electrical system or battery—while airplane 102 is unpowered. Because the motion sensors associated with the mode switching operation may draw only a small amount of current in the dormant mode of operation, airplane proximity detection power management system 100 may advantageously remain in this state for relatively long periods of time (e.g., several months or years) without draining the dedicated battery and without relying on the aircraft's electrical system or depleting the aircraft's battery.

When the motion data indicates that airplane 102 has experienced a level of movement in excess of a threshold level, the motion data may act as a trigger to activate the proximity sensors and to place airplane proximity detection power management system 100 in an active state. This may be triggered, for example, when the motion data indicates that airplane 102 has moved beyond a threshold distance and/or that the airplane has accelerated beyond a threshold acceleration within a threshold time period, which is further discussed below with reference to FIG. 3.

Once airplane proximity detection power management system 100 is in an active state (or mode) of operation, one or more of the proximity sensors may detect the presence of various objects external to airplane 102. In some embodiments, the presence of external objects may be detected as being either present or absent (e.g., a proximity sensor may detect the presence of an object when the object is of a minimum size and within a threshold detection distance from the location of the proximity sensor). But in other embodiments, the presence of external objects may be established by utilizing proximity data generated by a proximity sensor that is indicative of the distance to the object to a threshold distance, which may be compared to a threshold trigger distance.

For example, the proximity sensor may output a voltage level, a current level, or other suitable signal to indicate when an external object has been detected. Upon detecting this output, airplane proximity detection power management system 100 may cause alarm unit 106 (which may be mounted on or otherwise attached to the airplane 102 so that it may be heard by those towing the airplane 102) to issue an audible and/or visual alarm by sounding a buzzer, flashing a light, etc.

To provide another example, in accordance with embodiments in which the proximity data is indicative of the distance to an external object, airplane proximity detection power management system 100 may determine when a measured distance between a proximity sensor location and an external object is less than a threshold distance. Upon this condition being satisfied, airplane proximity detection power management system 100 may cause alarm unit 106 to issue an audible and/or visual alarm by sounding a buzzer, flashing a light, etc.

To provide an illustrative example, airplane 102 may be stationary, unpowered, and stored in a hangar. During this time, one or more motion sensors that are part of airplane proximity detection power management system 100 may be powered from one or more dedicated batteries (independent from the airplane's electrical system) and generating motion data periodically or continuously. The motion data may be monitored by one or more processors that may be integrated as part of each proximity detection unit 104.1-104.N, which is further discussed below with reference to FIG. 3. When tow vehicle 108 tows airplane 102 (which is still unpowered) from the hangar via tow bar 107, the motion data indicates this, and the proximity sensors of airplane proximity detection power management system 100 may be switched to the active mode of operation. Of course, aircraft may also be towed manually by a person via tow bar 107 (or another suitable tow bar) instead of via tow vehicle 108, in which case tow the system 100 functions in the same manner.

While the proximity sensors are in the active mode of operation and airplane 102 is still unpowered, tow vehicle 108 may tow airplane 102 such that the proximity sensor associated with proximity detection unit 104.3 generates proximity data indicating that the right wing of airplane 102 has come within a distance “d” of an external object 110, which may be a wall, support pillar, a portion of another aircraft, etc. Assuming that the distance d is less than a threshold triggering distance, airplane proximity detection power management system 100 may detect external object 110 when this condition is satisfied. Alternatively, the proximity sensor associated with proximity detection unit 104.3 may simply detect the presence of external object 110 when airplane 102's right wing is nearby an external object 110.

Regardless of how the detection of external object 110 occurs, embodiments include proximity detection unit 104.3 causing alarm unit 106 to sound an alarm upon external object 110 being detected. This alarm may be directed to the driver of tow vehicle 108, for example, as airplane 102 may be unmanned during a tow operation, thereby potentially preventing damage to airplane 102's right wing.

In various embodiments, airplane 102's electrical power system may also be monitored by one or more components that may be integrated as part of each proximity detection unit 104.1-104.N, which is further discussed below with reference to FIG. 3. Continuing the previous example, once one or more of proximity detection units 104.1-104.N determines that airplane 102 is powered on, the proximity sensors and motion sensors associated with the proximity detection units 104.1-104.N may be turned off or disabled, such that airplane proximity detection power management system 100 no longer performs proximity detection or motion detection. Or, alternatively, the system 100 may continue to function but draw power from the airplane's electrical system instead of the dedicated battery.

While airplane proximity detection power management system 100 is in this off state, one or more of proximity detection units 104.1-104.N may route power from airplane 102's electrical system to recharge the dedicated batteries. Once airplane 102 is again unpowered, one or more of proximity detection units 104.1-104.N may route power from the dedicated battery to the motion detectors, placing the proximity sensors back into a dormant state. Airplane proximity detection power management system 100 may remain in this dormant state until airplane 102 is once again moved, repeating the aforementioned process.

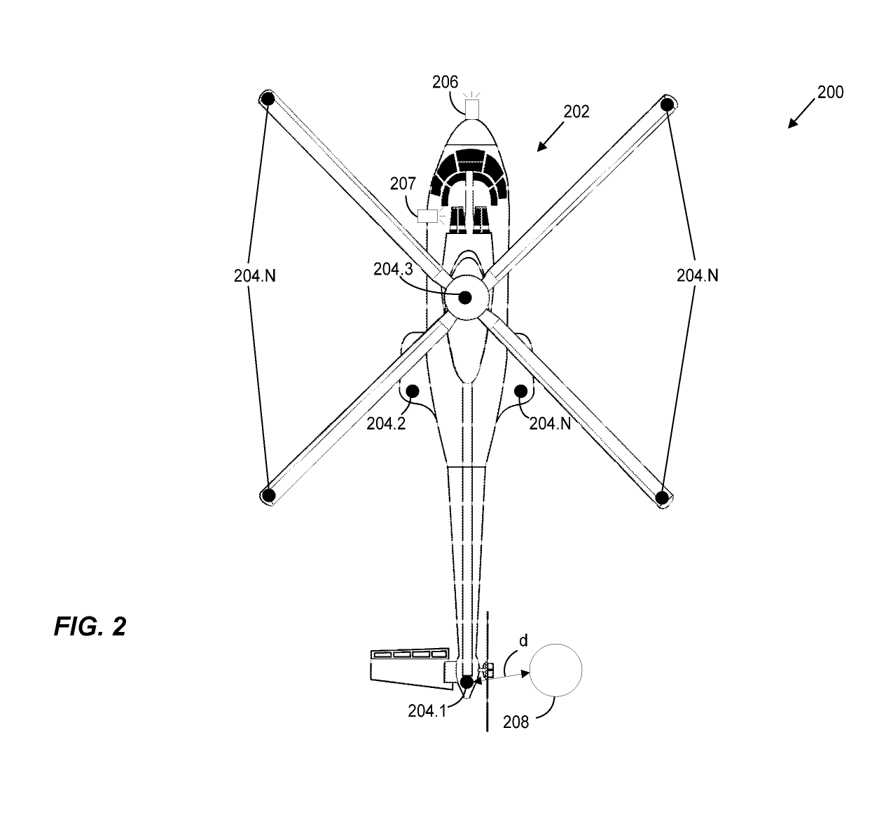

FIG. 2 is an illustration of a schematic illustration of an exemplary helicopter proximity detection power management system 200, in accordance with an embodiment of the present disclosure. Helicopter proximity detection power management system 200 may include a helicopter 202, N number of proximity detection units 204.1-204.N, an external alarm unit 206, an internal alarm unit 207, and one or more external objects 208. One or more proximity detection units 204.1-204.N, external alarm unit 206, and one or more external objects 208, as shown in FIG. 2, are substantially similar in function and configuration as one or more proximity detection units 104.1-104.N, alarm unit 106, and one or more external objects 110, respectively, as previously discussed above with reference to FIG. 1.

Because different vehicles may utilize different procedures and may have different needs based upon their design and the procedures used for transport, taxiing, landing, taking off, etc., embodiments may include the operation of airplane proximity detection power management system 100 being modified to take these differences into consideration. Helicopter proximity detection power management system 200, as discussed with continuing reference to FIG. 2, illustrates some examples of these differences—although the embodiments described herein may also be applicable to other vehicles, other aircraft, and/or to airplane proximity detection power management system 100.

For example, helicopter 202 may be stored in a hangar and towed in a similar manner as airplane 102. Therefore, similar to airplane proximity detection power management system 100, embodiments may include helicopter proximity detection power management system 200 functioning in a dormant mode until helicopter 202 is moved, causing external alarm unit 206 (which may be mounted on or otherwise attached to helicopter 202) to sound an audible and/or visual alarm when proximity detection unit 204.1 indicates that helicopter 202's tail is near external object 208.

However, when taxiing before takeoff, helicopter 202 typically flies several feet off the ground, and the pilot may not be able to see external object 208 or other objects close to helicopter 202's tail while taxiing. Therefore, embodiments may include helicopter proximity detection power management system 200 continuing to perform proximity detection and/or issuing alerts after helicopter 202 has been powered and/or while helicopter 202 is flying. In accordance with such embodiments, one or more of proximity detection unit 204.1-204.N (further discussed below), may switch the power supplied to one or more proximity sensors from the dedicated battery to the helicopter's electrical system while the dedicated battery is being recharged or not used. In this way, the proximity detection and alarm functions of helicopter proximity detection power management system 200 may be maintained even when helicopter 202 is powered on and/or in flight.

In various embodiments, one or more of proximity detection units 204.1-204.N may use sensors specific to the vehicle in which they are installed. For example, proximity detection units 204.1, 204.2, and 204.N may include directional proximity sensors similar to proximity detection units 104.1-104.N, as shown and discussed with reference to FIG. 1. But proximity detection unit 204.3 may implement a proximity sensor that takes advantage of the circular shape of helicopter's rotating rotor blades by utilizing a proximity sensor that measures proximity data (or performs object detection) omni-directionally from the mounting location at the rotor hub. As will be further discussed below with reference to FIG. 3, embodiments may include proximity detection units 204.1-204.N being active under certain conditions, based upon the type of proximity detection unit, and/or based upon each proximity detection unit 204.1-204.N's respective function.

In accordance with such embodiments, the proximity detection and alarm functions of helicopter proximity detection power management system 200 may be maintained when helicopter 202 is powered on and/or in flight, but disabled based upon other inputs from helicopter 202. For example, once helicopter 202 has taken off and is flying at a cruising altitude, these functions may be unnecessary. Therefore, embodiments may include the proximity detection and alarm functions of helicopter proximity detection power management system 200 reverting to an off state once helicopter 202 exceeds some threshold airspeed and/or elevation. For example, avionics and/or other controls may be provided in the cockpit of the helicopter to activate and deactivate proximity monitoring.

Additionally or alternatively, helicopter proximity detection power management system 200 may include internal alarm unit 207 that is directed to the cockpit. For example, internal alarm unit 207 may be implemented as a module alarm unit installation directed toward the pilot. To provide another example, internal alarm unit 207 may be implemented as part of a flight display unit within the cockpit of helicopter 202. In this way, a pilot may be additionally alerted to potential collisions with external objects during low flight, taxiing, low altitude maneuvering, etc., when the risk of such collisions would be greatest.

FIG. 3 is a block diagram of an exemplary proximity detection power management system 300, according to an embodiment. Embodiments of proximity detection power management system 300 may include fewer, additional, or suitable alternate components as those shown in FIG. 3 to facilitate the various functions of the embodiments as described herein.

Although FIG. 3 indicates several block components grouped together or separated from one another, this illustration is for exemplary purposes to describe the logical functions associated with various components of exemplary proximity detection power management system 300, and is not intended to limit the scope of the embodiments to the configuration shown in FIG. 3. For example, although proximity detection unit 301 is shown in FIG. 3 with battery unit 318 and control unit 319 as two separate components, proximity detection unit 301 may be implemented with any suitable number of integrated circuits, boards, chips, components, etc. Furthermore, proximity detection power management system 300 may include several components interconnected via one or more control links or power links, the latter being illustrated in bold. For purposes of simplicity, all interconnections between the various components of proximity detection power management system 300 are not shown in FIG. 3.

Proximity detection power management system 300 may include a proximity detection unit 301, a vehicle power system 316, and an alarm unit 340. In an embodiment, proximity detection unit 301 may be an implementation of one or more proximity detection units 104.1-104.N, as shown in FIG. 1. In accordance with such an embodiment, alarm unit 340 may be an implementation of alarm unit 106, while vehicle power system 316 may be an implementation of the electrical system of airplane 102, as shown in FIG. 1.

In another embodiment, proximity detection unit 301 may be an implementation of one or more proximity detection units 204.1-204.N, as shown in FIG. 2. In accordance with such an embodiment, alarm unit 340 may be an implementation of external alarm unit 206 and/or internal alarm unit 207, while vehicle power system 316 may be an implementation of the electrical system of helicopter 202, as shown in FIG. 2.

In an embodiment, proximity detection unit 301 may include a battery unit 318 and a control unit 319, which may be configured to communicate with one another using any suitable number and/or type of communication protocols via one or more wired and/or wireless links, such as via link 335, for example, as shown in FIG. 3.

Battery unit 318 may include a switching unit 320 and a battery 322. In an embodiment, switching unit 320 may be implemented as any suitable number and/or type of switching components configured to route power between vehicle power system 316, battery 322, and various components of control unit 319 as further discussed below. For example, switching unit 320 may be implemented as any suitable number and/or type of relays, electromechanical switches, etc., which may have any suitable number of poles and throws. In an embodiment, switching unit 320 may be configured to receive one or more data signals from control unit 319 via link 335 and to adjust the power routing between vehicle power system 316, battery 322, and/or one or more components of control unit 319 in response to these data signals.

For example, switching unit 320 may be configured to route power from vehicle power system 316 via link 325 to one or more components of control unit 319 via link 333 based upon one or more data signals received from control unit 319 via link 335. To provide another example, switching unit 320 may be configured to route power from vehicle power system 316 to recharge battery 322 via links 325 and 328 based upon one or more data signals received from control unit 319 via link 335. To provide yet another example, switching unit 320 may be configured to route power from battery 322 to one or more components of control unit 319 via links 327 and 331 based upon one or more data signals received from control unit 319 via link 335.

Although FIG. 3 shows three links 329, 331, and 333, embodiments include switching unit 320 routing power from vehicle power system 316 or battery 322 to any suitable number and/or combination of one or more components of control unit 319 based upon various conditions being satisfied. For example, link 333 may provide power to one or more components of control unit 319 from vehicle power system 316 while battery 322 may provide power to one or more components of control unit 319 via links 327 and 331. To provide another example, battery 322 may provide power to one or more components of control unit 319 directly, bypassing switching unit 320, via link 329. Switching unit 320 may provide power from either of vehicle power system 316 and/or battery 322 concurrently to different components of control unit 319 based upon the power needs of each components and/or various conditions being satisfied, which is further discussed below.

In an embodiment, one or more components of control unit 319 may be powered from battery 322, bypassing switching unit 320. For example, lower power consuming components (e.g., motion sensor 308) may draw power from battery 322 when proximity detection unit 301 is not in an off state and also draw power from battery 322 when proximity detection unit 301 is in a dormant or active state, regardless of the state of other components of control unit 319 and/or the state of switching unit 320.

In an embodiment, switching unit 320 may be set to a default and/or a “normally closed” state, which forms a default connection between vehicle power system 316, battery 322, and one or more components of control unit 319. For example, switching unit 320 may be configured to, in the absence of any signals received via link 335, have a default setting whereby control unit 319 draws power from battery 322 via links 327 and 331. Again, battery 322 may provide power to one or more components of control unit 319 via a hardwired, dedicated, and/or direct connection using link 329, thereby bypassing switching unit 320 to provide power to one or more components of control unit 319.

Battery 322 may be implemented as any suitable number and/or type of batteries. In an embodiment, battery 322 may be implemented as a rechargeable battery that may be recharged via vehicle power system 316 when switching unit 320 routes power from vehicle power system 316 to battery 322 via links 325 and 328. Battery 322 may be implemented as a battery having any suitable size, shape, and/or capacity to provide adequate power to control unit 319 for sustained periods.

Vehicle power system 316 may be implemented as any suitable number and/or type of vehicle power system, which may include, for example, an aircraft electrical system. Vehicle power system 316 may include one or more components of a vehicle's electrical system that may be utilized, for example, to power various components of the vehicle such as, for example, avionics, lighting, electronics, accessories, computers, navigation devices, heads up displays, etc. Vehicle power system 316 may provide power to battery unit 318, for example, via link 325. Vehicle power system 316 may include one or more batteries separate from battery 322, which may be used to start the vehicle, provide lighting prior to the engines being started, power various components of the vehicle during operation of the engines, etc.

In various embodiments, link 325 may include one or more wires, interconnects, ports, etc., that provide power from one or more locations in the vehicle in which proximity detection unit 301 is installed. For example, if proximity detection unit 301 is installed in the wing of an aircraft, then link 325 may represent one or more wires that ordinarily provide power to the wingtip lights. When proximity detection unit 301 is installed in an aircraft at this location, link 325 may be coupled to battery unit 318 via any suitable number of connections. For example, link 325 may be coupled to battery unit 318 by shunting a connection in parallel with the aircraft's existing power supply wires upon installation.

In various embodiments, one or more voltages, currents, and/or power levels of vehicle power system 316 may be monitored by one or more components of proximity detection unit 301 so that proximity detection unit 301 may determine whether the vehicle in which it is installed is in a powered or an unpowered state. A connection between vehicle power system 316 and proximity detection unit 301 is not shown in FIG. 3 for purposes of simplicity, but may include any suitable number and/or types of wired and/or wireless links.

Alarm unit 340 may be implemented as any suitable number and/or type of alarm configured to provide, for example, auditory, vibratory, and/or visual alerts to one or more persons. For example, alarm unit 340 may be implemented as various displays, speakers, buzzers, lights, etc. To provide additional examples, alarm unit 340 may be a portion of one or more components that may be integrated as part of the vehicle in which proximity detection unit 301 is installed, such as an integrated flight deck, a primary display unit, etc.

In some embodiments, alarm unit 340 may be mounted on the outside of a vehicle, such as an aircraft, for example, to provide a warning when one or more portions of a towed aircraft are within a threshold distance of an external object, as previously discussed with reference to FIG. 1. In other embodiments, alarm unit 340 may be installed on the inside of a vehicle to provide a warning, for example, when one or more portions of a taxiing helicopter are within a threshold distance of an external object, as previously discussed with reference to FIG. 2. In yet other embodiments, alarm unit 340 may constitute two or more separate alarm units, one being mounted outside of a vehicle (e.g., mounted on or otherwise attached to the vehicle) and another being mounted inside of the vehicle.

Alarm unit 340 may be configured to receive one or more data signals from control unit 319 (e.g., via link 337), which triggers alarm unit 340 to issue an alarm. These data signals may be any suitable type of data signal that cause alarm unit 340 to issue an alarm based upon the implementation of alarm unit 340. For example, if alarm unit 340 is implemented as a visual warning displayed as part of a flight display unit, then the data signals may cause the flight display unit to display a suitable indication of an external object collision hazard on the flight display unit. To provide another example, if alarm unit 340 is implemented as a buzzer or speaker mounted to the outside of an aircraft, then the data signals may include voltage and/or current level assertions that trigger a relay, switch, etc., of alarm unit 340 to close, resulting in an alarm being issued.

Control unit 319 may include a processor 302, one or more cameras 303, a communication unit 304, a proximity sensor 306, a motion sensor 308, a sensor array 309, and a memory 310. In an embodiment, processor 302 may be implemented as any suitable type and/or number of processors. For example, processor 302 may be implemented as an off-the-shelf microprocessor, an application specific integrated circuit (ASIC), an embedded processor, etc. In an embodiment, processor 302 may be configured to enter a low-power mode (e.g., a standby, sleep mode, dormant mode, etc.) when proximity detection unit 301 enters a dormant mode of operation, which is further discussed below. When in a dormant mode of operation, processor 302 may draw power from battery 322 on the order of microwatts and “wake-up” upon proximity detection unit 301 transitioning to an active mode of operation, as further discussed below.

Processor 302 may be configured to communicate with one or more of camera 303, communication unit 304, proximity sensor 306, motion sensor 308, sensor array 309, and/or memory 310 via one or more wired and/or wireless interconnections, such as any suitable number of data and/or address buses, for example. These interconnections are not shown in FIG. 3 for purposes of simplicity.

Processor 302 may be configured to operate in conjunction with one or more of camera 303, communication unit 304, proximity sensor 306, motion sensor 308, sensor array 309, and/or memory 310 to process and/or analyze data, to store data to memory 310, to retrieve data from memory 310, to cause alarm unit 340 to issue an alarm, to receive, process, and/or interpret proximity data via proximity sensor 306, to receive, process, and/or interpret motion data via motion sensor 308, to determine whether the vehicle in which proximity detection unit 301 is installed has experienced a threshold amount of movement based upon the motion data received via motion sensor 308, to determine whether proximity data indicates that proximity sensor 306 is within a threshold distance of an external object, to determine whether proximity sensor 306 has detected the presence of an external object, to monitor the power state of vehicle power system 316, to cause battery unit 318 to route power to various components of control unit 319 from vehicle power system 316 or battery 322, to cause proximity detection unit 301 to transition between various modes of operation, etc.

Camera 303 may be configured to capture pictures, videos, and/or to generate live video data. Camera 303 may include any suitable combination of hardware and/or software such as image sensors, optical stabilizers, image buffers, frame buffers, charge-coupled devices (CCDs), complementary metal oxide semiconductor (CMOS) devices, etc., to facilitate this functionality.

In an embodiment, camera 303 may be housed within or otherwise integrated as part of proximity detection unit 301, having a lens positioned to capture live video data from the vantage point of proximity sensor 306 and/or from additional vantage points of the vehicle in which proximity detection unit 301 is installed. For example, camera 303 may be strategically mounted on an aircraft to capture live video and generate live video data from the vantage point of an aircraft's tail.

Communication unit 304 may be configured to support any suitable number and/or type of communication protocols to facilitate communications between processor 302, one or more other components of control unit 319, one or more components of proximity detection power management system 300, and/or one or more additional proximity detection units installed in the same vehicle.

Communication unit 304 may be configured to work in conjunction with processor 302 to receive any suitable type of information via one or more other components of control unit 319 and/or one or more components of proximity detection power management system 300. Communication unit 304 may likewise be configured to work in conjunction with processor 302 to transmit any suitable type of information via one or more other components of proximity detection power management system 300. Communication unit 304 may be implemented with any suitable combination of hardware and/or software, which may be configured to send and/or receive data in accordance with one or more suitable communication protocols to facilitate this functionality. For example, communication unit 304 may be implemented with any suitable number of wired and/or wireless transceivers, ports, connectors, etc.

In some embodiments, the vehicle in which proximity detection unit 301 is installed may utilize proximity data from several installed proximity detection units. These embodiments may be particularly useful, for example, when an aircraft utilizes 360 degree proximity coverage during flight. To do so, the aircraft may include a centralized primary component (e.g., flight display unit), which may receive data from several of the installed proximity detection units, aggregate this data, and display proximity warnings, a bearing and range between obstacles, etc. In accordance with such embodiments, communication unit 304 may be configured to communicate with a centralized primary component in an aircraft to transmit any suitable type of data (e.g., live video data, proximity range and heading data, whether an alarm has been issued, etc.) for processing by the centralized primary component.

To provide another example, communication unit 304 may facilitate processor 302 receiving proximity data from proximity sensor 306, receiving motion data from motion sensor 308, sending one or more data signals to switching unit 320, sending one or more signals to alarm unit 340 to cause an alarm to be issued, monitoring the powered state of vehicle power system 316 via one or more monitored voltages, currents, power levels, etc.

Proximity sensor 306, motion sensor 308, and/or sensor array 309 may be advantageously mounted or otherwise positioned within proximity detection unit 301 (or some other portion of the vehicle in which proximity detection unit 301 is installed) to facilitate their respective functions. Proximity sensor 306, motion sensor 308, and/or sensor array 309 may be configured to sample sensor data, to generate sensor data, and/or to perform external object detection continuously or in accordance with any suitable recurring schedule, such as, for example, on the order of several milliseconds (e.g., 10 ms, 100 ms, etc.), once per every second, once per every 5 seconds, once per every 10 seconds, once per every 30 seconds, once per minute, etc. Each of proximity sensor 306, motion sensor 308, and/or sensor array 309 may be configured differently or in the same manner regarding the technique and timing schedule in which each sensor component samples sensor data, generates sensor data, and/or performs external object detection.

Proximity sensor 306 may be implemented as any suitable number and/or type of sensors configured to detect the presence, range, and/or bearing of nearby obstacles of any suitable size. For example, proximity sensor 306 may be implemented as a radio detection and ranging (RADAR) system, an ultrasonic sensor, a laser rangefinder, a light RADAR (LiDAR) system, a capacitive proximity sensor, an inductive proximity sensor, a capacitive displacement sensor, a Doppler-effect proximity sensor, an eddy-current proximity sensor, a magnetic proximity sensor, an infrared proximity sensor, a photocell proximity sensor, a sound navigational ranging (SONAR) sensor, a fiber optic proximity sensor, a Hall effect proximity sensor, combinations thereof, and the like.

In an embodiment, proximity sensor 306 may be implemented as a RADAR sensor operating at any suitable frequency or frequency bands, such as any suitable portion (or the entire portion) of the C band (4-8 GHz), the X band (8-12 GHz), the Ku band (12-18 GHz), the Ka band (24-40 GHz), the millimeter wave band (40-300 GHz), the V band, (40-75 GHz), the W band (75-110 GHz), etc.

In various embodiments, proximity detection unit 301 may implement various types of proximity sensors 306 depending on the location of the vehicle in which proximity detection unit 301 is installed, the type of alerts generated via alarm unit 340, etc. For example, when installed in an aircraft wingtip (e.g., proximity detection unit 104.3, as shown in FIG. 1), proximity sensor 306 may need to provide proximity data in a range on the order of several feet (or detect the presence of external objects within a range on the order of several feet) and have a field of view on the order of 45 degrees, as aircraft are generally towed relatively slowly and this provides sufficient time for an operator to react to an alarm issued by alarm unit 340.

To provide another example, embodiments include proximity sensors 306 detecting the presence of an object having a threshold size when the object is within a threshold distance of a particular one of proximity sensors 306. In accordance with such embodiments, a proximity sensor may not necessarily generate data indicative of a distance to a detected object, but an indication of whether an object has been detected. These embodiments may be particularly useful, for example, when a low-cost and/or low-power sensor is desired.

To provide an illustrative example, a proximity sensor used for an aircraft wingtip may be configured as an infrared proximity sensor whereby an output voltage increasingly varies with an increased proximity to external objects. When the output voltage exceeds a threshold minimum voltage, a detection event may be triggered. Such proximity sensors are available using infrared technologies and other suitable technologies to detect obstacles having a minimum size on the order of, for example, 0.5 m².

To provide yet another example, when installed in a helicopter tail (e.g., proximity detection unit 204.1, as shown in FIG. 2), proximity sensor 306 may need to provide flare guidance. In such an implementation, proximity sensor 306 may provide proximity data in a range of, for example, 150-200 feet (or detect the presence of external objects within a similar range), have a field of view on the order of 45 degrees, determine the range of the ground with a resolution and accuracy similar to a RADAR altimeter, and be configured to detect obstacles having a size on the order of, for example, 0.054 m² or smaller.

In an embodiment, proximity sensor 306 may operate in a dormant, active, or off mode of operation based upon various conditions that are interpreted by control unit 319, which are further discussed below. For example, proximity sensor 306 may initially be disabled when the vehicle in which proximity detection unit 301 is installed is stationary, drawing power from neither vehicle power system 316 nor from battery 322. But when motion data generated via motion sensor 308 indicates that the vehicle in which proximity detection unit 301 is installed has moved, then proximity sensor 306 may be placed into an active state, for example, via processor 302. In this active state, proximity sensor 306 may actively measure, sample, and/or generate proximity data, which is received and processed by processor 302 to determine whether an alert should be issued via alarm unit 340.

Motion sensor 308 may be implemented as any suitable number and/or type of sensors configured to detect the movement of the vehicle in which proximity detection unit 301 is installed and to generate motion data. For example, motion sensor 308 may be implemented as one or more accelerometers, MEMS devices, gyroscopic devices, tilt switches, microwave sensors, ultrasonic sensors, tomographic motion sensors, etc.

In an embodiment, motion sensor 308 may be implemented as a low power three-axis accelerometer (e.g., utilizing power on the order of a few microwatts) when proximity detection unit 301 is in a dormant mode of operation. In the dormant mode of operation, motion sensor 308 may draw power from battery 322. Processor 302 may, while proximity detection unit 301 is in the dormant mode of operation, continue to receive and process motion data generated by motion sensor 308 to determine whether the vehicle in which proximity detection unit 301 is installed has undergone a sufficient amount of motion to trigger proximity detection unit 301 transitioning to the active proximity detection mode of operation, which is further discussed below. Processor 302 and motion sensor 308 may periodically generate and process motion data in the dormant mode of operation or continuously generate and process motion data.

Sensor array 309 may be implemented as any suitable number and/or type of sensors configured to measure, monitor, and/or quantify one or more characteristics of proximity detection unit 301's environment. For example, sensor array 309 may measure sensor data such barometric pressure, velocity, etc. In some embodiments, control unit 319 may utilize sensor data and/or data generated by one or more components of the vehicle in which proximity detection unit 301 is located instead of or in addition to the sensor data generated by sensor array 309. For example, in embodiments in which proximity detection unit 301 is installed in an aircraft, the aircraft would typically generate speed and altitude data. Embodiments may include proximity detection unit 301 utilizing this data instead of or in addition to the sensor metrics generated by sensor array 309.

Examples of suitable sensor types implemented by sensor array 309 may include one or more accelerometers, gyroscopes, compasses, speedometers, magnetometers, barometers, thermometers, proximity sensors, light sensors (e.g., light intensity detectors), photodetectors, photoresistors, photodiodes, Hall Effect sensors, electromagnetic radiation sensors (e.g., infrared and/or ultraviolet radiation sensors), ultrasonic and/or infrared range detectors, humistors, hygrometers, altimeters, microphones, radio detection and ranging (RADAR) systems, light RADAR (LiDAR) systems, etc.

In accordance with various embodiments, memory 310 may be a computer-readable non-transitory storage device that may include any suitable combination of volatile memory (e.g., a random access memory (RAM)) or non-volatile memory (e.g., battery-backed RAM, FLASH, etc.). Memory 310 may be configured to store instructions executable on processor 302, such as the various memory modules illustrated in FIG. 3 and further discussed below, for example. These instructions may include machine readable instructions that, when executed by processor 302, cause processor 302 to perform various acts as described herein.

Memory 310 may also be configured to store any other suitable data used in conjunction with proximity detection unit 301, such as data received from one or more of other proximity detection units, a log of issued alerts, proximity data generated via proximity sensor 306, motion data generated via motion sensor 308, sensor data generated via sensor array 309, etc.

Mode module 312 may be a region of memory 310 configured to store instructions that, when executed by processor 302, cause processor 302 to perform various acts in accordance with applicable embodiments as described herein. In an embodiment, mode module 312 may include instructions that, when executed by processor 302, cause processor 302 to cause switching unit 320 to provide power to one or more components of control unit 319 based upon whether various trigger conditions have been satisfied.

The various trigger conditions may be based upon, for example, any suitable combination of conditions indicative of the vehicle's movement and/or the vehicle's status. For example, conditions may take into account whether the vehicle in which proximity detection unit 301 has been installed has undergone a sufficient amount of motion to trigger a mode transition. To provide another example, conditions may take into account whether the vehicle is in a powered state, whether the vehicle is in flight (if an aircraft), taxiing, etc. These conditions may be modified based upon the particular vehicle in which proximity detection unit 301 is installed and/or the particular functions provided by proximity detection unit 301.

In the various examples discussed below, processor 302 may execute instructions stored in mode module 312 to transition proximity detection unit 301 between a dormant state, an active state, and an off state. These states are used herein interchangeably with the aforementioned modes of operation. In an embodiment, the dormant state may be implemented by processor 302 causing battery unit 318 (e.g., by sending one or more data signals via link 335) to route power such that switching unit 320 does not provide power to proximity sensor 306 but does provide power via battery 322 (e.g., via links 327 and 331) to motion sensor 308.

Furthermore, the active state may be implemented by processor 302 causing battery unit 318 to route power such that switching unit 320 provides power to proximity sensor 306 and motion sensor 308 via battery 322 (e.g., via links 327 and 331). In embodiments in which the active state is maintained when the vehicle is powered and/or during flight, processor 302 may, upon detecting the vehicle being powered and/or flight conditions being satisfied (as discussed below) cause battery unit 318 to route power in a specific manner. For example, switching unit 320 may provide power to proximity sensor 306 and motion sensor 308 via vehicle power system 316 (e.g., via links 325 and 333), while battery 322 is recharged (e.g., via links 325 and 328).

Additionally, the off state may be implemented by processor 302 causing battery unit 318 (e.g., by sending one or more data signals via link 335) to route power such that battery unit 318 does not provide power to either proximity sensor 306 or motion sensor 308, and/or via processor 302 disabling the operation of proximity sensor 306 and/or motion sensor 308. When in the off state, battery unit 318 may route power such that switching unit 320 provides vehicle power from vehicle power system 316 to recharge battery 322 (e.g., via links 325 and 328).

Using airplane proximity detection power management system 100 as an example, as shown in FIG. 1, processor 302 may execute instructions stored in mode module 312 to place proximity detection unit 301 in one of a dormant, active, or off state as summarized below in Table 1.

TABLE 1

| Has airplane | | |
|---|---|---|
| moved from | | |
| the stationary | Is airplane | State of proximity |
| position? | powered? | detection unit 301 |
| No | No | Dormant, battery 322 not |
| | | recharging |
| Yes | No | Active, battery 322 not |
| | | recharging |
| X | Yes | Off, battery 322 recharging |

Using helicopter proximity detection power management system 200 as an example, as shown in FIG. 2, processor 302 may execute instructions stored in mode module 312 to place proximity detection unit 301 in one of a dormant, active, or off state as summarized below in Table 2.

TABLE 2

| Has helicopter | | | |
|---|---|---|---|
| moved from | | | |
| the stationary | Is helicopter | Is helicopter | State of proximity |
| position? | powered? | in flight? | detection unit 301 |
| No | No | X | Dormant, battery 322 |
| | | | not recharging |
| X | Yes | No | Active, battery 322 |
| | | | recharging |
| X | Yes | Yes | A) Off, battery 322 |
| | | | recharging; OR |
| | | | B) Active, battery 322 |
| | | | recharging |

As shown in Table 1, some embodiments include proximity detection unit 301 initially being in a dormant state, switching to an active proximity detection state when sufficient movement of the airplane (or other vehicle in which proximity detection unit 301 is installed) is detected, and switching to an off state once the airplane or other vehicle is powered, such as for taxiing, takeoff, sustained flight, landing, etc.

But as shown in Table 2, other embodiments include proximity detection unit 301 initially being in a dormant state, switching to an active proximity detection state when sufficient movement of the helicopter (or other vehicle in which proximity detection unit 301 is installed) is detected, but remaining in the active proximity detection state even while the helicopter or other vehicle is powered on. In such embodiments, proximity detection unit 301 may either (A) enter an off state once the helicopter starts flying (e.g., is no longer taxiing, reaches a threshold elevation, reaches a threshold speed, etc.) or (B) continue to operate in the active proximity detection state after takeoff.

In various embodiments, the determination of whether the aircraft (or other vehicle in which proximity detection unit 301 is installed) is powered may be made by processor 302 executing instructions stored in mode module 312 and identifying whether certain conditions have been met. For example, processor 302 may execute instructions stored in mode module 312 to measure and/or monitor a voltage and/or current level associated with vehicle power system 316. That is, vehicle power system 316 may have one or more vehicle batteries separate from battery 322. When the vehicle in which proximity detection unit 301 is installed is off, the voltage and/or current measured by processor 302 may be less than some threshold value. When the vehicle is powered on and the engines are running, such as during a taxi, takeoff, or sustained flight, the voltage and/or current measured by processor 302 may increase in excess of the threshold voltage.

For example, in aircraft electrical power systems, the measured voltage is typically less than 27 Volts direct current (VDC) when the aircraft engines are not running and the aircraft is unpowered. Therefore, processor 302 may determine that an aircraft in which proximity detection unit 301 is installed is unpowered when this measured voltage is less than 27 VDC, and that the aircraft is powered when the voltage is greater than or equal to 27 VDC. This increase in voltage may be caused by, for example, the additional current generated by the aircraft's alternators that recharge the aircraft's batteries, thereby increasing the operating voltage of the aircraft's electrical power system.

Furthermore, the determination of whether the aircraft (or other vehicle in which proximity detection unit 301 is installed) is “in flight,” may be made by processor 302 executing instructions stored in mode module 312 and identifying whether certain conditions have been met. For example, processor 302 may analyze barometric pressure data generated via sensor array 309 to identify when the aircraft has reached a threshold altitude, and transition proximity detection unit 301 to the off state accordingly.

To provide another example, processor 302 may analyze velocity data generated via sensor array 309 to identify when the aircraft has reached a threshold velocity, maintained a threshold velocity over a threshold sampling period, etc., and transition proximity detection unit 301 to the off state accordingly.

To provide yet another example, processor 302 may receive sensor data from other components of the aircraft (or vehicle in which proximity detection unit 301 is installed) that indicate altitude and/or vehicle speed, and use this data to determine whether a threshold altitude or velocity has been exceeded, respectively, and transition proximity detection unit 301 to the off state accordingly.

In an embodiment, processor 302 may execute instructions stored in mode module 312 to identify whether the vehicle in which proximity detection unit 301 is installed has moved a sufficient amount to transition from dormant state to the active proximity detection state. This determination may be made, for example, via various analyses of the motion data that indicate whether the vehicle has exceeded a threshold amount of movement.

For example, if motion sensor 308 is implemented as an accelerometer, then the motion data may indicate the acceleration of proximity detection unit 301 in one or more of the x, y, and z-axes. A sudden movement of the vehicle in which proximity detection unit 301 is installed would therefore result in a sudden acceleration of proximity detection unit 301 in one or more of these axes. In an embodiment, processor 302 may identify, from the motion data, that proximity detection unit 301 has accelerated in excess of a threshold acceleration or force within a threshold sampling time period. In other words, processor 302 may identify that the vehicle has maintained a threshold acceleration over a threshold time period in a manner consistent with the vehicle being towed (e.g., the vehicle moves with increasing speed for one second, two seconds, etc.). When this is the case, processor 302 may identify that the vehicle in which proximity detection unit 301 is installed has moved from a stationary position, and transition proximity detection unit 301 from the dormant state to the active proximity detection state.

To provide another example, processor 302 may analyze the motion data to determine whether a threshold number of vehicle accelerations have occurred over some threshold sampling time period. That is, sudden vehicle movements may be required to maneuver an aircraft from a tight hangar spot. These sudden movements may not be maintained for a sufficiently long period, but processor 302 may still identify movement of the aircraft if the movement data indicates smaller accelerometer data values (compared to the embodiment described above) when a threshold number of these smaller movements occur within some threshold time period (e.g., 3 small movements within 10 or 15 seconds). Again, when this is the case, processor 302 may identify that the vehicle in which proximity detection unit 301 is installed has moved from a stationary position, and transition proximity detection unit 301 from the dormant state to the active proximity detection state.

In various embodiments, processor 302 may analyze the motion data to filter out transient changes in acceleration, which may be caused by electrical noise, wind, or other extraneous factors that occur when the vehicle is not being towed. By utilizing a threshold time period, the two aforementioned techniques may adequately address this issue. However, embodiments may also include processor 302 discriminating and/or weighting various axes over others when motion sensor 308 is implemented as a three-axis accelerometer. For example, a towing operation would generally be associated with an aircraft moving forward more so than other directions. In an embodiment, processor 302 may execute instructions stored in mode module 312 to more heavily weight accelerometer data in the axis corresponding to such movements, thereby further decreasing the possibility of false alarms that would improperly cause proximity detection unit 301 to transition from the dormant state to the active proximity detection state.

Although the aforementioned techniques regarding the detection of vehicle movement may be utilized to accurately transition proximity detection unit 301 from the dormant state to the active proximity detection state, false alarms or other scenarios may occur that could potentially allow proximity detection unit 301 to continue running in an active mode prior to the vehicle being powered on. For example, once a vehicle is initially towed, processor 302 may detect this movement and transition proximity detection unit 301 from the dormant state to the active proximity detection state. But once towed, the vehicle may once again sit stationary while maintenance is performed, awaiting service by mechanics, etc. In such a case, proximity detection unit 301 may continue to draw power from battery 322 while operating in the active proximity detection state, potentially draining battery 322.

Therefore, embodiments include processor 302 executing instructions stored in mode module 312 to revert proximity detection unit 301 from the active proximity detection state back to the dormant state when various conditions are detected. For example, processor 302 may utilize a timeout condition such that, once proximity detection unit 301 has been operating in the active proximity detection state for a threshold time duration (e.g., 10 minutes, 15 minutes, etc.) and no additional motion is detected over this duration, processor 302 may revert proximity detection unit 301 back to the dormant state until additional vehicle motion is detected.

To provide another example, processor 302 may continue to analyze the motion data to identify changes in the acceleration of the vehicle that would be consistent with a towing operation. That is, in practice a tow vehicle will usually not tow a vehicle at a constant speed in the same direction. Therefore, embodiments may include processor 302 analyzing the motion data over a time period to verify, once proximity detection unit 301 is operating in the active proximity detection state, that the motion data continues to indicate changes in vehicle acceleration greater than a threshold value. If these changes are not observed for a threshold period of time (e.g., 10 seconds, 20 seconds, etc.) then processor 302 may revert proximity detection unit 301 back to the dormant state until additional vehicle motion is detected.

Alarm module 314 may be a region of memory 310 configured to store instructions that, when executed by processor 302, cause processor 302 to perform various acts in accordance with applicable embodiments as described herein. In an embodiment, alarm module 314 includes instructions that, when executed by processor 302, cause processor 302 to interpret proximity data (or other detection signals generated when an external object is detected) generated by proximity sensor 306 and to conditionally issue an alert via alarm unit 340 based upon the proximity data (or the detection signals). The proximity data may be analyzed in accordance with the type of sensor implemented by proximity sensor 306, the location of proximity sensor 306 within the vehicle, etc.

For example, if proximity sensor 306 is implemented as an infrared proximity sensor in the wingtip of an aircraft, then processor 302 may execute instructions stored in alarm module 314 to monitor one or more signals (or other data) generated by proximity sensor 306 in accordance with a suitable protocol and/or format to determine whether an external object is detected proximate to the aircraft's wingtip. Processor 302 may send a command to alarm unit 340 (e.g., via link 337) to issue an alarm upon the detection of the external object.

To provide another example, if proximity sensor 306 is implemented as an ultrasonic proximity sensor in the wingtip of an aircraft, then processor 302 may execute instructions stored in alarm module 314 to process the proximity data in accordance with a suitable protocol and/or format to determine the distance between the wingtip and an external object as measured by proximity sensor 306. Processor 302 may compare this measured distance to a threshold distance and, if the measured distance is equal to or less than the threshold distance, send a command to alarm unit 340 (e.g., via link 337) to issue an alarm.

To provide yet another example, if proximity sensor 306 is implemented as a RADAR device in the tail of a helicopter, then processor 302 may execute instructions stored in alarm module 314 to process the proximity data in accordance with a suitable protocol and/or format to determine the distance between the tail and an external object measured by proximity sensor 306. Processor 302 may compare the measured distance to a threshold distance and, if the measured distance is equal to or less than the threshold distance, send a command to alarm unit 340 (e.g., via link 337) to issue an alarm.

To provide an additional example, if proximity sensor 306 is implemented as a RADAR device at the top of a helicopter rotor hub, then processor 302 may execute instructions stored in alarm module 314 to process the proximity data in accordance with a suitable protocol and/or format to determine a distance and heading relationship between one or more obstacles with respect to the helicopter's current heading. Processor 302 may compare the measured distance to the one or more obstacles to a threshold distance and, if the measured distance is equal to or less than the threshold distance, send a command to alarm unit 340 (e.g., via link 337) to issue an alarm. Continuing this example, processor 302 may additionally communicate with an integrated flight deck in the helicopter such that the integrated flight deck displays the distance and heading relationship between one or more obstacles with respect to the helicopter's current heading.

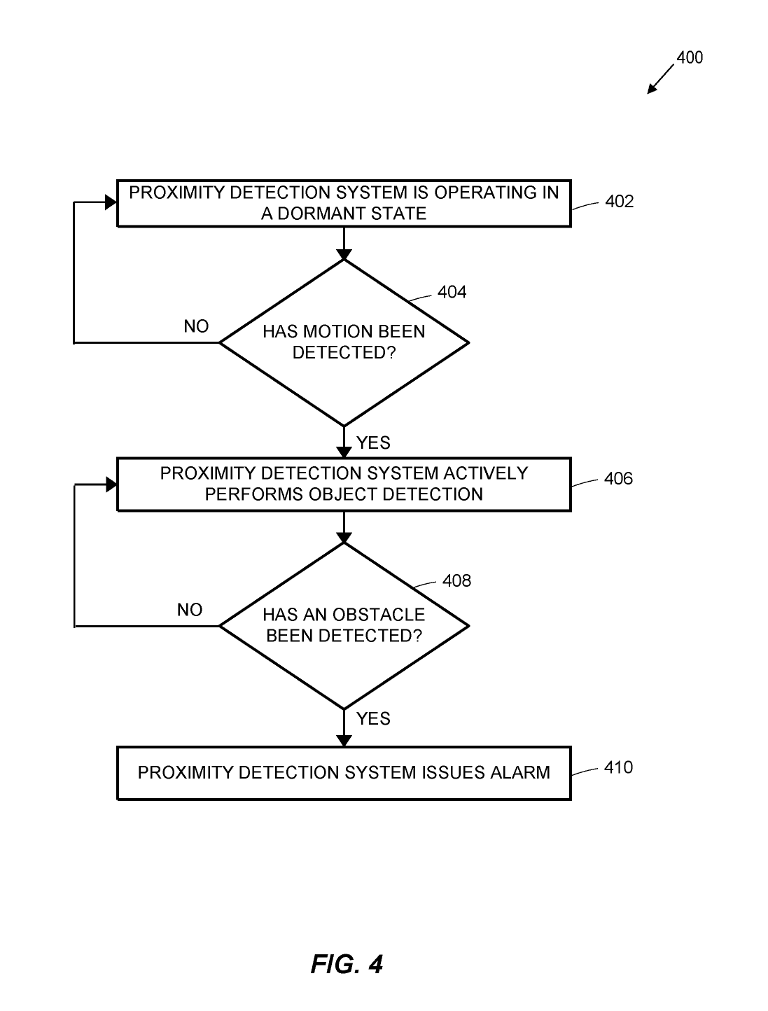

FIG. 4 illustrates a method flow 400, according to an embodiment. In an embodiment, one or more regions of method 400 (or the entire method 400) may be implemented by any suitable device. For example, one or more regions of method 400 may be performed by proximity detection unit 301, as shown in FIG. 3.

In an embodiment, method 400 may be performed by any suitable combination of one or more processors, applications, algorithms, and/or routines, such as processor 302 executing instructions stored in mode module 312 and/or alarm module 314, for example, as shown in FIG. 3. Further in accordance with such an embodiment, method 400 may be performed by one or more processors working in conjunction with one or more other components, such as processor 302 working in conjunction with one or more of communication unit 304, proximity sensor 306, motion sensor 308, sensor array 309, memory 310, one or more components of battery unit 318, vehicle power system 316, alarm unit 340, one or more portions of the vehicle in which proximity detection unit 301 is installed, etc.

Method 400 may start when proximity detection system 301 is operating in a dormant state (block 402). In an embodiment, the dormant state may include, for example, motion sensor 308 and processor 302 drawing power from battery 322 while proximity sensor 306 remains dormant or unpowered. Again, in the dormant state, processor 302 may monitor the movement data generated by motion sensor 308 (block 402).

Method 400 may include processor 302 continuing to monitor the motion data generated by motion sensor 308 (block 402) to determine whether sufficient motion of the vehicle in which proximity detection system 301 is installed has been detected (block 404). This may include, for example, analyzing the motion data in any suitable manner to make this determination, as previously discussed with reference to FIG. 3 above (block 404). If sufficient motion has been detected, then method 400 may continue to begin actively performing object detection (block 406). Otherwise, method 400 may continue such that proximity detection system 301 remains in the dormant state (block 402).

Method 400 may include proximity detection system 301 actively performing object detection (block 406). This may include, for example, proximity detection system 301 monitoring an output from proximity sensor 306 to determine whether an external object has been detected, which may be processed and analyzed by processor 302 (block 406). This may also include, for example, proximity sensor 306 sampling proximity data, which is processed and analyzed by processor 302 (block 406).

Method 400 may include processor 302 determining whether an obstacle has been detected (block 408). This may include, for example, processor 302 making a determination from the sampled proximity data (block 406) that an obstacle has been detected within a threshold distance from proximity sensor 306 (block 408). This may also include, for example, the receipt of an output generated by proximity sensor 306 indicating the presence of an external object (block 408). If so, method 400 may continue to issue an alarm (block 410). Otherwise, method 400 may proceed such that proximity sensor 306 continues actively performing object detection (block 406).

Method 400 may include processor 302 issuing an alarm (block 410). This may include, for example, transmitting one or more signals to alarm unit 340 (block 410). This may also include, for example, asserting a voltage line to cause alarm unit 340 to issue an alarm (block 410). Again, the issued alarm may be any suitable type of alarm to notify a pilot and/or other person that the obstacle has been detected (block 410).

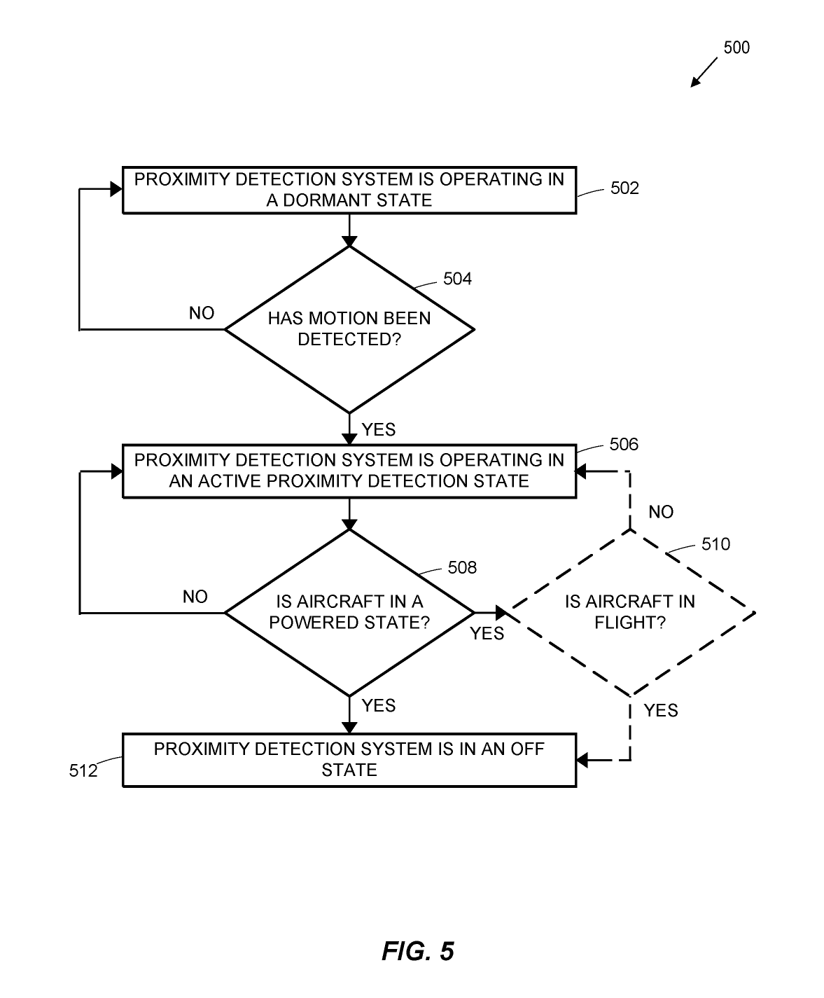

FIG. 5 illustrates a method flow 500, according to an embodiment. In an embodiment, one or more regions of method 500 (or the entire method 500) may be implemented by any suitable device. For example, one or more regions of method 500 may be performed by proximity detection unit 301, as shown in FIG. 3.

In an embodiment, method 500 may be performed by any suitable combination of one or more processors, applications, algorithms, and/or routines, such as processor 302 executing instructions stored in mode module 312 and/or alarm module 314, for example, as shown in FIG. 3. Further in accordance with such an embodiment, method 500 may be performed by one or more processors working in conjunction with one or more other components, such as processor 302 working in conjunction with one or more of communication unit 304, proximity sensor 306, motion sensor 308, sensor array 309, memory 310, one or more components of battery unit 318, vehicle power system 316, alarm unit 340, one or more portions of the vehicle in which proximity detection unit 301 is installed, etc.

Method 500 may start when proximity detection system 301 is operating in a dormant state (block 502). In an embodiment, the dormant state may include, for example, motion sensor 308 and processor 302 drawing power from battery 322 while proximity sensor 306 remains dormant or unpowered. Again, in the dormant state, processor 302 may monitor the movement data generated by motion sensor 308 (block 502).

Method 500 may include processors 302 continuing to monitor the motion data generated by motion sensor 308 (block 502) to determine whether sufficient motion of the vehicle in which proximity detection system 301 is installed has been detected (block 504). This may include, for example, analyzing the motion data in any suitable manner to make this determination, as previously discussed with reference to FIG. 3 above (block 504). If sufficient motion has been detected, then method 500 may continue such that proximity detection system 301 transitions from the dormant state (block 502) to operate in an active proximity detection state (block 506). Otherwise, method 500 continues such that proximity detection system 301 maintains operation in the dormant state (block 502).

Method 500 may include proximity detection system 301 operating in the active proximity detection state (block 506). In the active proximity detection state, proximity detection system 301 may actively perform object detection (block 506). This may include, for example, proximity detection system 301 monitoring an output from proximity sensor 306 to determine whether an external object has been detected, which may be processed and analyzed by processor 302 (block 506). This may also include, for example, proximity sensor 306 sampling proximity data, which is processed and analyzed by processor 302 (block 506).

Method 500 may include processor 302 determining whether the vehicle is in a powered state (block 508). This may include, for example, a determination from a voltage and/or current level associated with the vehicle power system that that the vehicle has been powered on (e.g., engines on, taxiing, etc.) (block 508). If so, embodiments include method 500 branching into separate flows based upon the implementation and/or application of proximity detection system 301.

In one embodiment, when the vehicle is an aircraft and a powered aircraft state is detected (block 508), method 500 may optionally include a determination of whether the aircraft is in flight (block 510). This may include, for example, a determination of whether the aircraft is above a threshold altitude or travelling in excess of a threshold velocity (block 510). If the aircraft is in flight (block 510), method 500 may continue such that proximity detection system 301 transitions from the active proximity detection state (block 506) to operate in the off state (block 512). Of course, in other embodiments, which are not shown in FIG. 5 for simplicity but discussed above with reference to FIG. 3, proximity detection system 301 may maintain operation in the active proximity detection state even when the aircraft is in flight (block 506).

In another embodiment, when a powered aircraft state is detected (block 508), method 500 may continue such that proximity detection system 301 transitions from the active proximity detection state (block 506) to operate in an off state (block 512). This off state may include, for example, routing power such that proximity sensor 306 and motion sensor 308 are unpowered and/or recharging battery 322 from the aircraft's internal power system (block 512).

However, if the vehicle is not in a powered state (block 508), embodiments include method 500 continuing such that proximity detection system 301 maintains operation in the active proximity detection state (block 506) (e.g., the “NO” path from block 508 as shown in FIG. 5).

Although the foregoing text sets forth a detailed description of numerous different embodiments, it should be understood that the detailed description is to be construed as exemplary only and does not describe every possible embodiment because describing every possible embodiment would be impractical, if not impossible. In light of the foregoing text, numerous alternative embodiments may be implemented, using either current technology or technology developed after the filing date of this patent application.

What is claimed is:

1. A proximity-monitoring device mounted on an aircraft, comprising:
a motion sensor configured to generate motion data indicative of the aircraft's motion;
a proximity sensor configured to detect a presence of an object external to the aircraft;
a battery unit including a battery, the battery unit being configured to provide power to the motion sensor and to selectively provide power to the proximity sensor; and
a processor configured to:
determine whether the aircraft has exceeded a threshold amount of movement based upon the motion data,
cause the battery unit to activate the proximity sensor when the aircraft has exceeded the threshold amount of movement, and
cause an alert to be issued when the proximity sensor is activated by the battery unit and the proximity sensor detects the presence of the object external to the aircraft.

2. The proximity-monitoring device of claim 1, wherein the proximity sensor is selected from the group consisting of:
a radio detection and ranging (RADAR) system;
an ultrasonic sensor;
an infrared sensor;
a laser rangefinder; and
a light RADAR (LiDAR) system.

3. The proximity-monitoring device of claim 1, wherein the motion data includes accelerometer data, and
wherein the threshold amount of movement is determined based upon the accelerometer data indicating that the aircraft has maintained a threshold acceleration for a threshold time period.

4. The proximity-monitoring device of claim 1, wherein the processor is further configured to determine that the aircraft is powered on when the aircraft's electrical system exceeds a threshold voltage level, and to cause the battery unit to route power such that the aircraft's electrical system recharges the battery while the aircraft is powered on.

5. The proximity-monitoring device of claim 4, wherein the processor is further configured to deactivate the proximity sensor by causing the battery unit to route power such that the battery does not provide power to the proximity sensor while the battery is being recharged.

6. The proximity-monitoring device of claim 1, wherein the processor is further configured to cause the alert to be issued by sounding an alarm that is audible outside of the aircraft.

7. The proximity-monitoring device of claim 1, wherein the processor is further configured to deactivate the proximity sensor by causing the battery unit to route power such that the battery does not provide power to the proximity sensor until it is detected that the aircraft has exceeded the threshold amount of movement based upon the motion data.

8. The proximity-monitoring device of claim 1, wherein the proximity sensor is mounted in a wingtip of the aircraft.

9. A proximity-monitoring device mounted in an aircraft having an electrical system, the proximity-monitoring device comprising:
a motion sensor configured to generate motion data indicative of the aircraft's motion;
a proximity sensor configured to detect a presence of an object external to the aircraft;
a switching unit configured to selectively route power from one of a battery or the aircraft's electrical system to the proximity sensor, and to selectively route power from the aircraft's electrical system to the battery to recharge the battery; and
a processor configured to:
determine whether the aircraft has exceeded a threshold amount of movement based upon the motion data,
determine whether the aircraft is powered or unpowered based upon a voltage of the aircraft's electrical system,
cause the switching unit to route power such that the battery provides power to the proximity sensor when the aircraft has exceeded the threshold amount of movement,
cause the switching unit to route power such that the aircraft's electrical system recharges the battery when the aircraft is powered, and
cause an alert to be issued when the proximity sensor is powered by the battery, the aircraft is unpowered, and the proximity sensor detects the presence of the object external to the aircraft.

10. The proximity-monitoring device of claim 9, wherein the proximity sensor is selected from the group consisting of:
a radio detection and ranging (RADAR) system;
an ultrasonic sensor;
an infrared sensor;
laser rangefinder; and
light RADAR (LiDAR) system.

11. The proximity-monitoring device of claim 9, wherein the motion data includes accelerometer data, and
wherein the threshold amount of movement is determined based upon the accelerometer data indicating that the aircraft has maintained a threshold acceleration for a threshold time period.

12. The proximity-monitoring device of claim 9, wherein the processor is further configured to disable operation of the proximity sensor by causing the switching unit to route power such that the battery does not provide power to the proximity sensor while the battery is being recharged.

13. The proximity-monitoring device of claim 9, wherein the processor is further configured to cause the alert to be issued by sounding an alarm that is audible outside of the aircraft.

14. The proximity-monitoring device of claim 9, wherein the proximity sensor is mounted in a wingtip of the aircraft.
